(19) United States
(12) Patent Application Publication
(10) Pub. No.: US 2012/0000592 A1
(43) Pub. Date: Jan. 5, 2012

(54) LABEL, LABELING SYSTEM AND METHOD OF LABELING FOR CONTAINERS FOR DRUG PRODUCTS

(75) Inventors: Joseph MASE, Barrington, IL (US); Lindsey Thomas, Cary, IL (US)

(73) Assignee: Sagent Pharmaceuticals, Inc., Schaumburg, IL (US)

(21) Appl. No.: 13/175,175

(22) Filed: Jul. 1, 2011

Related U.S. Application Data
(60) Provisional application No. 61/360,920, filed on Jul. 1, 2010.

(51) Int. Cl. B65C 3/00; B65C 9/00

(52) U.S. Cl. 156/60; 156/349; 40/299.01; 40/310; 40/312

(57) ABSTRACT

The label and labeling system provide a way to label containers and packaging for drug products in a manner that makes the drug readily identifiable and distinguishable for a clinician to help reduce the potential for medication errors. The study of product characteristics, usage behavior, environment and storage practices informs the design process and yields packaging and labeling that is tailored for a particular product and set of users. Information of particular importance for the clinician is emphasized through selective placement, orientation, and text size, among other characteristics. In addition, a design and color scheme may be employed to assist with proper dosage selection and reduce the potential of administering a wrong dose. Through the label and labeling system, at-a-glance accurate readability and product differentiation are enhanced.

### CROSS-REFERENCE TO RELATED APPLICATIONS

This application claims priority under 35 U.S.C. §119(e) to provisional U.S. Patent Application No. 61/360,920, filed on Jul. 1, 2010, the disclosure of which is expressly incorporated by reference herein in its entirety.

### BACKGROUND OF THE INVENTION

Drug products, also referred to as pharmaceutical products or medicines, pass through a supply chain before reaching a patient. At each phase of distribution and touch points by caregivers (e.g., pharmacists, doctors, nurses, etc.), the drug product and dosage amount must be accurately chosen among many other drugs with similar names and packaging. From wholesaler to patient, a typical injectable drug product is handled at least seventeen times. This amounts to many opportunities for errors to be made involving that drug.

Multiple different pharmaceutical products may be provided in one shipment by a manufacturer, wholesaler and/or distributor in a hospital or private pharmacy. Typically, wholesalers and distributors aggregate a complete order to a single hospital or pharmacy location that contains different products from numerous manufacturers. Using the information contained on the packaging of a particular drug product, the pharmacy staff must then sort and organize the drug for storage in their facility. Pharmacy staff later distribute the drug throughout a healthcare facility prior to administration to the patient. Typically, a nurse will have access to multiple drugs on his/her floor for multiple patients, and the nurse must decipher the proper drug and dosage just prior to administration. This process is complicated because drug products are provided by multiple manufacturers who use template-based labeling systems that all tend to look the same. Clinicians are forced to handle thousands of pharmaceutical products in any given institution that all have different packaging using different, and often difficult to distinguish or read, labeling template systems. Regulatory requirements further limit vial sizes that create further difficulties with labeling.

Injectable drug products present further issues that can make their proper selection and administration more difficult. For example, injectable drugs typically are supplied in vials that have similar shapes, sizes, materials (e.g., glass), colors (e.g., clear), stoppers and caps. As a result, injectable products supplied in vials are often difficult to differentiate from one another based solely on the physical properties of the vial.

Labeling used on containers for drug products is required to contain multiple indicia relating to properties of the drug. For example, the name, strength, concentration, and expiration date of the drug product are among the types of information shown on a drug container label or package. The following additional information must be present on the label: route of administration; “Rx Only” statement; vial contents; dosage information; National Drug Code (NDC) number; labeling raw material number; single or multi-dose vial identifier; bar code (including number); lot number; storage information; manufacturer/distributor; country of origin; and warning statements. Although information requirements are regulated by the U.S. Food and Drug Administration (FDA), these regulations allow for design variability.

In many instances, the container for the drug is relatively small (e.g., a 2 mL vial is only about 1.5 inches tall yielding a label that is only about 0.75 inches tall), which makes it difficult to conspicuously present all of the information necessary for identifying a particular drug. Drug containers also tend to have a similar appearance across different drugs and dosages due to template-based labeling, which can make it difficult to distinguish one drug (and its total strength and concentration) from another. Even within a single drug product produced by the same manufacturer, numerous different strengths and concentrations can exist that all look alike. The reason for this is that many drug companies select one standard template that is used for every one of their products, thereby rendering them almost identical except for the drug specific information. The FDA has recognized that look-alike and sound-alike drugs pose a particularly high risk of being involved in a medication error and that name confusion is one of the most common causes of medication errors.

Despite these risks, many pharmaceutical companies assign disproportionate prominence to their name and/or logo, while that space could be used to make key drug name and dosage information more prominent. Examples of corporate labeling templates that illustrate these issues are set forth at FIG. 1 and FIG. 2.

### BRIEF SUMMARY

The labeling system of the invention provides a way to label containers and packaging for drug products in a manner that makes the drug and dose readily identifiable and distinguishable for a clinician. Information of particular importance for the clinician is emphasized through selective placement and orientation of text, as well as text size, font and style, among other characteristics. In addition, a color scheme and unique design elements may be employed thereby assisting with proper dosage selection and reducing the potential of administering a wrong dose. Through this labeling system of the invention, at-a-glance accurate readability and product differentiation is enhanced. The combination of unique design and use of color creates a synergistic differentiating effect that cannot be achieved by solely varying color within a single template design.

The invention is directed to a label for a container for a drug product. The label contains indicia identifying various characteristics of the drug product. For example, these properties may include the name of the drug product, concentration, fill volume, and total strength of the drug product. Concentration is the units of drug product per single volume unit that is often expressed in units of drug product per one milliliter. Total strength is the total units of drug product or, in other words, concentration times the fill volume that is often expressed in milligrams.

The label has a first section and a second section for providing the required indicia. The first section has a background color that is uniquely associated with the total strength and/or concentration. The second section of the label has a different background color than that used in the first section to distinguish the second section from the first section.

In one aspect of the invention, the concentration of the drug product is provided in the second section of the label. This aspect is referred to herein as the “concentration” format label. In another aspect of the invention, the total strength and fill volume of the drug product is provided in the second section of the label. This aspect is referred to herein as the “total strength” format label.

The invention is also directed to a labeling system for multiple containers for a drug product including labels present on two or more containers utilizing the label of the invention described herein. In the labeling system, each label includes:
a first section having a background color and text identifying the drug product name and the fill volume in the container; and
a second section having a background color and text identifying the concentration of the drug product,
wherein the background color of the first section is different from the background color of the second section, and
wherein the color of the text in the first section is different from the color of the text in the second section, and
wherein the background color of the first section of the label is different for each container for drug product having a different total strength.

The invention is further directed to a labeling system for multiple containers for a drug product including labels present on two or more containers, wherein each label includes:
a first section having a background color and text identifying the drug product name; and
a second section having a background color and text identifying the total strength of the drug product and fill volume,
wherein the background color of the first section is different from the background color of the second section, and
wherein the color of the text in the first section is different from the color of the text in the second section, and
wherein the background color of the first section of the label is different for each container for drug product having a different total strength.

In another aspect, the invention relates to a method of labeling a container for a drug product using the label of the invention described herein including:
utilizing indicia on a label for the drug product, the indicia identifying properties of the drug product, the properties including a name of the drug product, concentration, total strength and fill volume;
selecting a background color for a first section of the label containing the name of the drug product, such color being uniquely associated with the total strength of the drug product; and
selecting a background color for a second section of the label containing the concentration of the drug product, wherein the background color of the second section is different that the background color of the first section.

### BRIEF DESCRIPTION OF THE DRAWINGS

FIG. 1 is an illustration of a comparative labeling template for a line of injectable drug products.

FIG. 2 is an illustration of a comparative labeling template for a line of injectable drug products.

FIG. 3 is a front view of pharmaceutical product containers utilizing the labeling system of the invention with labels having the total strength format.

FIG. 4 is a front view of a representative pharmaceutical product container utilizing the label of the invention.

FIG. 5 is a representative flat label prior to being applied to a vial container for the pharmaceutical product container shown in FIG. 4.

FIG. 6 is a top view of a cap for the pharmaceutical product container shown in FIG. 4.

FIG. 7 is a top view of a ferrule for the pharmaceutical product container shown in FIG. 4.

FIG. 8 is another representative flat label prior to being applied to a vial container for a pharmaceutical product container utilizing a label having the total strength format.

FIG. 9 is a perspective view taken from the front and top of pharmaceutical product containers utilizing the labeling system shown in FIG. 3.

FIG. 10 shows representative flat labels prior to being applied to a vial containers for pharmaceutical product containers utilizing the labeling system shown in FIG. 3 with labels having the concentration format.

FIGS. 11, 12, 13, 14, 15, 16, 17, 18, and 19 show representative unassembled cartons utilizing the labels of the invention.

FIG. 20 is a front view of pharmaceutical product containers utilizing the labeling system of the invention with labels having the concentration format.

FIG. 21 is a perspective view of representative assembled cartons utilizing the labels of the invention with the labels having the concentration format.

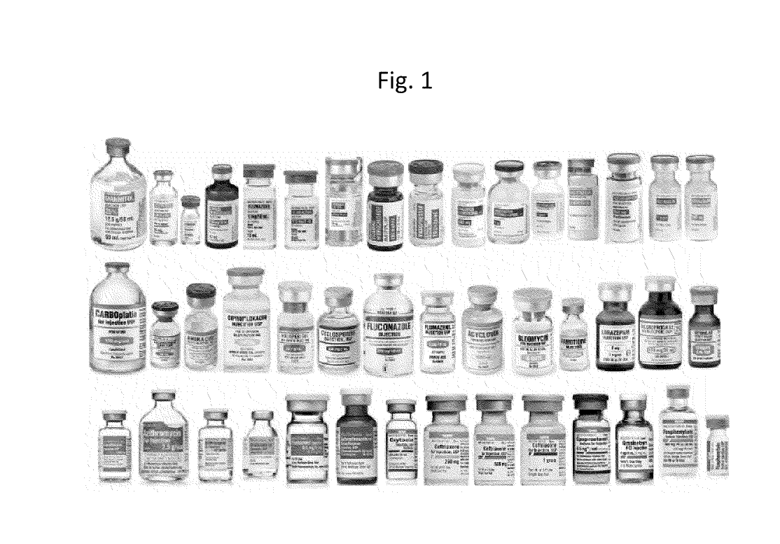

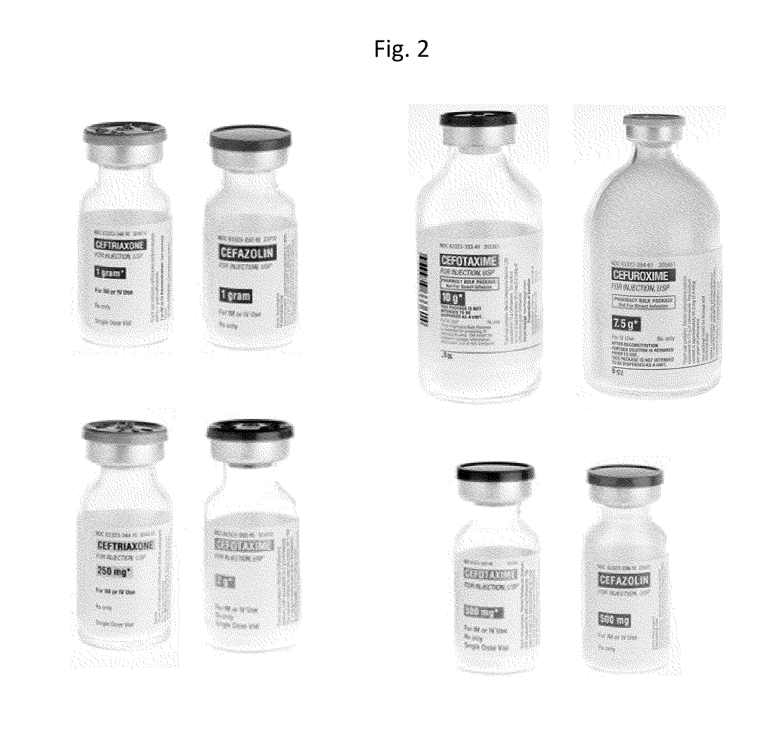

### DETAILED DESCRIPTION

Generally, the most important information to provide to a clinician on a container for a drug product to ensure proper administration and minimization of medication errors is the drug name, dose-related information, fill volume, and total strength), route of administration, and any warnings or cautionary statements. Dose-related information may include concentration (i.e., amount of drug per unit volume), fill volume and total strength (i.e., total amount of drug present or, in other words, concentration times fill volume). In particular, the concentration and total strength are essential for administering the proper amount of the drug. When the fill volume is equal to 1 mL and the concentration is measured per mL, the total strength is equal to the concentration. When, however, the fill volume is greater than 1 mL and the concentration is measured per mL, the total strength is greater than the concentration.

In current labeling systems, such as heparin for example, only the concentration is provided on containers. Thus, when containers, such as vials, have a fill volume larger than 1 mL, a clinician is required to perform a secondary calculation to determine the total strength and ensure that the correct amount of the drug is given to a patient. This scenario adds to the potential for human error due to either a miscalculation of the total strength or mistakenly assuming that the concentration equals the total strength.

The label for a container for a drug product of the invention contains indicia identifying various characteristics of the drug product. For example, these characteristics may include the name of the drug, concentration, fill volume, and total strength of the drug. The label has a first section and a second section for providing the required indicia. The first section has a background color that is uniquely associated with the total strength and/or concentration. The second section of the label has a different background color than that used in the first section to distinguish the second section from the first section.

In an aspect using a label having the concentration format, the concentration per 1 mL of the drug product is provided in the second section of the label. The concentration may be expressed as amount of drug product “per mL”. The number “1” or word “one” may optionally be included before “mL”. The amount of drug product may be identified on the concentration format label in any suitable units including, but not limited, to USP units (as defined by the United States Pharmacopeia), International Units (as defined by the International Conference for the Unification of Formulas), milligrams or grams or the like.

The second section in the concentration format label can be positioned at any suitable location on the label. Preferably, the second section is located in part or in whole with in the first section of the label. More preferably, the second section containing the concentration is located in close proximity to the drug product name and even more preferably directly below the drug product name without any other text provided between the drug product name and second section.

The concentration can be positioned at any suitable location within the second section of the label. Preferably, for concentrations of 10,000 units (e.g., USP units, mg, etc.) or greater, the number is positioned to begin at the left edge of the second section. For concentrations of less than 10,000, the number is indented from the left edge of the section to leave a space, thereby promoting the readability of the concentration number.

The concentration format label may further identify the fill volume of the container. The fill volume is the total volume of liquid present in the container. The fill volume may be provided at any suitable location on the label. For example, the fill volume may be provided in the first section of the label in close proximity to the concentration set forth in the second section. Preferably, the fill volume is recited directly below the concentration. This arrangement on the concentration format label is typically used when the fill volume is 1 mL.

Alternatively, the fill volume may be provided in a third section of the label that has a background color that is different from the background colors for the first and second sections. Preferably, the background color of the third section identifying the fill volume is black and the text in the third section is white. Alternatively, the third section may have a background color that is unique for a particular fill volume.

The third section, in which the fill volume is recited, may be provided at any suitable location on the label. For example, the third section is provided in close proximity to the concentration set forth in the second section. Preferably, the third section is located adjacent to and directly below the second section. Even more preferably, the start of the text of the fill volume is directly below the start of the text of the concentration such that the indentations of both the concentration and fill volume from the edge of the label are the same.

The fill volume may alternatively be provided in the second section of the label directly below the concentration.

In another aspect using the label having the total strength format, the total strength of the drug product and fill volume are provided in the second section of the label. The total strength of the drug product is expressed as an amount of the drug product. The amount of drug product may be identified on the total strength format label in any suitable format including, but not limited, to USP units (as defined by the United States Pharmacopeia), International Units (as defined by the International Conference for the Unification of Formulas), milligrams or grams. The fill volume is expressed as a volume of the drug product. The volume of the drug product may be identified in any suitable units including, but not limited to milliliters or liters. Preferably, the total strength and fill volume are identified in a single line as the total strength “per ______ mL” where the fill volume is provided before “mL”.

The second section in the total strength format label can be positioned at any suitable location on the label. Preferably, the second section is located in part or in whole with in the first section of the label. More preferably, the second section containing the total strength and fill volume is located in close proximity to the drug product name and even more preferably directly below the drug product name without any other text provided between the drug product name and second section.

The total strength and fill volume can be positioned at any suitable location within the second section of the label. Generally, the total strength is identified to the fill volume. Preferably, for total strengths of 10,000 units (e.g., USP units, mg, etc.) or greater, the number is positioned to begin at the left edge of the second section. For total strengths of less than 10,000, the number is indented from the left edge of the section to leave a space, thereby promoting the readability of the total strength number.

The total strength format label may further identify the concentration of the drug product. The concentration may be provided at any suitable location on the label. For example, the concentration may be provided in the first section of the label in close proximity to the total strength and fill volume set forth in the second section. Preferably, the concentration is recited directly below the total strength and fill volume.

Alternatively, the concentration may be provided in a third section of the label that has a background color that is different from the background colors for the first and second sections. Preferably, the background color of the third section identifying the concentration is white and the text in the third section is black. Alternatively, the third section may have a background color that is unique for a particular fill volume.

The third section of the total strength format label, in which the concentration is recited, may be provided at any suitable location on the label. For example, the third section is provided in close proximity to the total strength and fill volume set forth in the second section. Preferably, the third section is located adjacent to and directly below the second section. Even more preferably, the start of the text of the concentration is directly below the start of the text of the total strength such that the indentations of both the total strength and concentration from the edge of the label are the same. Alternatively, when the total strength is a number with more digits than the concentration (e.g., the total strength is 10,000 or greater and the concentration is less than 10,000), the two numbers may employ commas that are lined up with one above the other to improve readability of the figures.

The total strength format label may optionally further include a second identification of the fill volume in the first section of the label in addition to the inclusion of the fill volume in the second section. Preferably, the second identification of the fill volume is present when the fill volume is greater than 1 mL. More preferably, the second identification of the fill volume is located directly below the second section or, if present, the third section of the total strength format label. When present, the second identification of the fill volume can be provided adjacent to a reference to either “Multi-Dose Vial” or “Single-Dose Vial”.

The text used for the labels of the invention may have any suitable color. The color of the text is generally selected to improve readability by a clinician or other individual handling the container. Typically, the text is either black or white to distinguish the text from the background color. Alternatively, the text may have a color that is the same as that used as the background for different section of the label. For example, the color of the text of the drug product name may be the same as that used for the concentration. Thus, for multiple vials having the same concentration but different fill volumes, the color of the drug product name and other text may be the same. The use of the same color may assist the user in identifying the concentration of drug product present in the container.

The invention can be used for any suitable pharmaceutical drug product. The drug product is typically an injectable drug product that is supplied in multiple concentrations and multiple strengths. The drug products useful with the invention include, but are not limited to, anti-infectives, anticoagulants, anesthetics, and chemotherapeutic drug products. Preferably, the label and labeling system of the invention is used for heparin.

For heparin, the drug is available as either a sodium product or lock flush product. Both may be given to patients by intravenous or subcutaneous administration. The sodium product has a therapeutic purpose, while the lock flush product is used to flush an IV line. The use of the sodium product in place of the lock flush product or vice versa could have serious implications a patient, including death.

To avoid confusion between the two products, different labels and labeling system may be utilized for each and/or different container types could be utilized for each. For example, lock flush products could be provided in pre-filled syringes while the therapeutic doses could be provided in vial form to avoid confusion between the two types of drug products. Alternatively, the lock flush products could be packaged in vials with labels that are very distinct from those labels used for the Heparin Sodium Injection, USP.

In a preferred embodiment of the invention, the color of the cap is the same as the background color of the first section of the label, representing the total strength of the drug product contained in the vial. The cap may also contain information about the drug including, for example, the drug product name, concentration, total strength and/or fill volume. In addition, the cap may include warnings regarding the use of the drug product. Preferably, when the drug product is Heparin Sodium Injection, USP for administration to a patient, the cap contains the warning “NOT FOR LOCK FLUSH”.

Information may be provided on any suitable location on the cap or ferrule. For example, information may be included on the top of the cap or ferrule. If the cap or ferrule extends below the top of the container, information may be included on the edge of the cap or ferrule that extends below the top. Information on the edge of the cap or ferrule is preferably visible when the container is sitting upright on a shelf.

The color of the ferrule may be the same as the color of the cap which is the same as the background color of the first section of the label. The ferrule may also contain information about the drug including, for example, the drug product name, concentration, total strength and/or fill volume. In addition, the ferrule may include warnings regarding the use of the drug product. Preferably, when the drug product is Heparin Sodium Injection, USP used for administration to a patient, the ferrule contains the warning “NOT FOR LOCK FLUSH”.

The invention is further directed to a labeling system for multiple containers of a drug product comprising labels present on two or more containers. Preferably, the labeling system utilizes the concentration format labels. Alternatively, the labeling system utilizes the total concentration format labels.

The labeling system includes at least two labels applied to containers for a drug product having the same concentration and different total strength and different fill volume. Preferably, one of the labels is applied to a container having a fill volume of 1 mL and another label is applied to a container having a fill volume of more than 1 mL. The background color of first section of the label for the container having a 1 mL fill volume is the same as the background color of the second section of the label for the container having a fill volume of more than 1 mL.

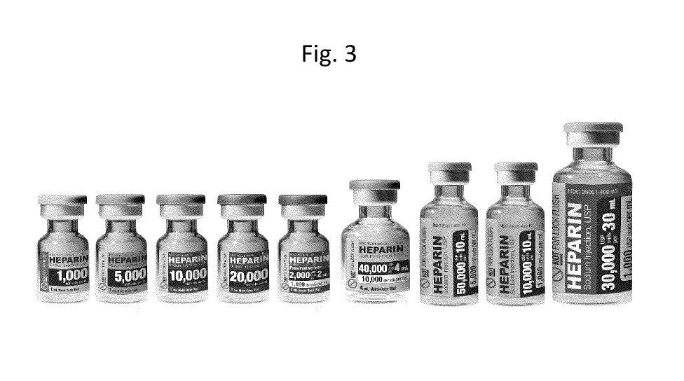

Turning to the figures, a labeling system of the invention used on to a variety of containers (illustrated as vials) and concentrations of a drug product is shown in FIG. 3. In this example, all of the vials are used for the drug product Heparin Sodium Injection, USP. The heparin labeling system may include two or more of the following total strengths and fill volumes:
1. 1,000 USP units per mL in 1 mL fill volume having a yellow color for the background of the first section of the label and black color for the background of the second section;
2. 5,000 USP units per mL in 1 mL fill volume having an orange color for the background of the first section of the label and black color for the background of the second section;
3. 10,000 USP units per mL in 1 mL fill volume having a brown color for the background of the first section of the label and black color for the background of the second section;
4. 20,000 USP units per mL in 1 mL fill volume having a red color for the background of the first section of the label and black color for the background of the second section;
5. 2,000 USP units per 2 mL in 2 mL fill volume (concentration of 1,000 USP units per 1 mL) having a purple color for the background of the first section of the label and black color for the background of the second section;
6. 40,000 USP units per 4 mL in 4 mL fill volume (concentration of 10,000 USP units per 1 mL) having a light green color for the background of the first section of the label, black color for the background of the second section, and white color for the background of the third section;
7. 50,000 USP units per 10 mL in 10 mL fill volume (concentration of 5,000 USP units per 1 mL) having a grey color for the background of the first section of the label, black color for the background of the second section, and white color for the background of the third section;
8. 10,000 USP units per 10 mL in 10 mL fill volume (concentration of 1,000 USP units per 1 mL) having a pink color for the background of the first section of the label, black color for the background of the second section, and white color for the background of the third section; and
9. 30,000 USP units per 30 mL in 30 mL fill volume (concentration of 1,000 USP units per 1 mL) having a dark green color for the background of the first section of the label, black color for the background of the second section, and white color for the background of the third section.

Another possible total strength and fill volume to include in a labeling system for heparin is 50,000 USP units per 5 mL in 5 mL fill volume (concentration of 10,000 USP units per 1 mL).

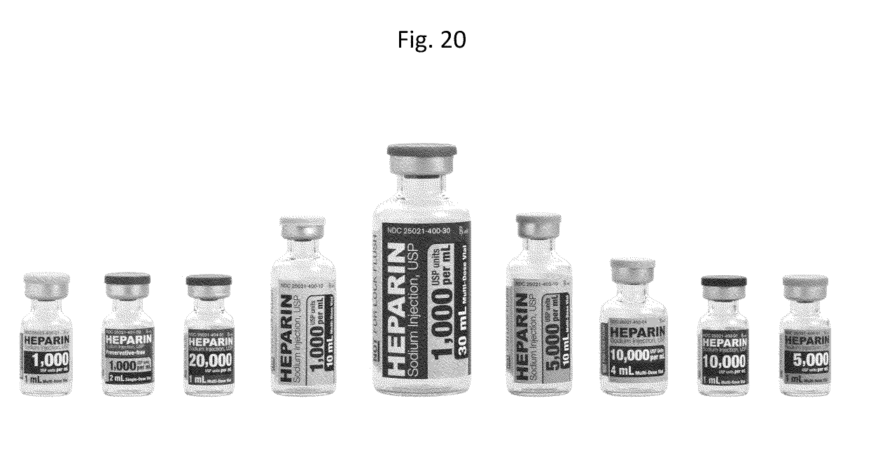

Another embodiment of the labeling system of the invention using concentration format labels applied to a variety of containers (illustrated as vials) and concentrations of Heparin Sodium Injection, USP is shown in FIG. 20. The heparin labeling system may include two more or more of the following concentrations and fill volumes:
1. 1,000 USP units per mL in 1 mL fill volume having a yellow color for the background of the first section of the label and black color for the background of the second section;
2. 5,000 USP units per mL in 1 mL fill volume having an orange color for the background of the first section of the label and black color for the background of the second section;
3. 10,000 USP units per mL in 1 mL fill volume having a brown color for the background of the first section of the label and black color for the background of the second section;
4. 20,000 USP units per mL in 1 mL fill volume having a red color for the background of the first section of the label and black color for the background of the second section;
5. 1,000 USP units per mL in 2 mL fill volume (total strength of 2,000 USP units) having a purple color for the background of the first section of the label, yellow color for the background of the second section, and black color for the background of the third section;
6. 10,000 USP units per mL in 4 mL fill volume (total strength of 40,000 USP units) having a light green color for the background of the first section of the label, brown color for the background of the second section, and black color for the background of the third section;
7. 5,000 USP units per mL in 10 mL fill volume (total strength of 50,000 USP units) having a grey color for the background of the first section of the label, orange color for the background of the second section, and black color for the background of the third section;
8. 1,000 USP units per mL in 10 mL fill volume (total strength of 10,000 USP units) having a pink color for the background of the first section of the label, yellow color for the background of the second section, and black color for the background of the third section; and
9. 1,000 USP units per mL in 30 mL fill volume (total strength 30,000 USP units) having a dark green color for the background of the first section of the label, yellow color for the background of the second section, and black color for the background of the third section.

On each label, the labeling system layout includes a variety of sections, font styles, font sizes, text orientation, and colors that are used to distinguish properties of the drug and emphasize certain information for a clinician. Important information on the label can be organized and presented in a manner such that it can be read without rotating the vial. Font size, style and contrasting colors have been chosen with the intent of maximizing readability. Less essential information is deemphasized and presented in a manner such that it does not interfere with the readability of more important information.

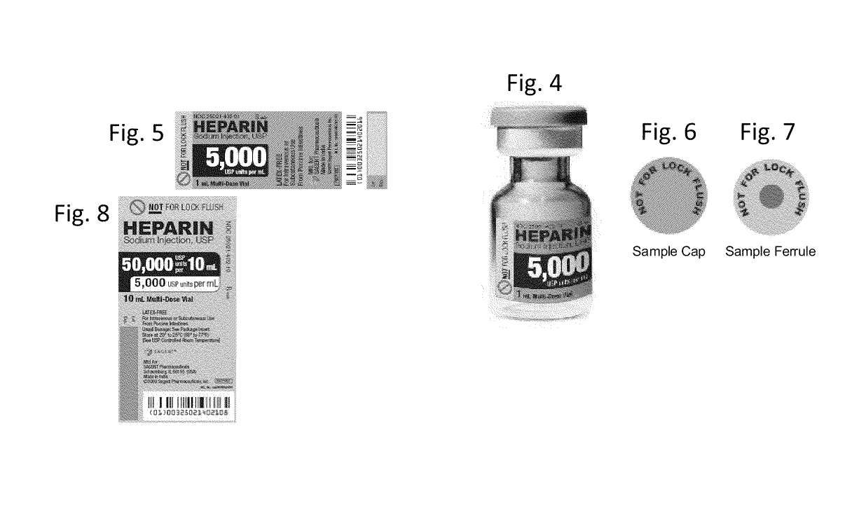

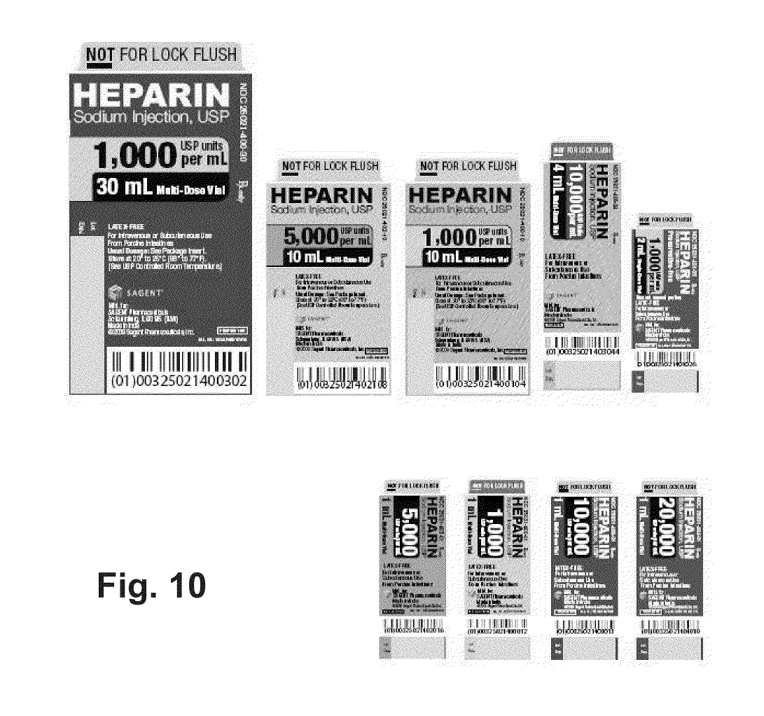

To assist with accurate drug and dosage identification, a labeling system is shown in FIG. 3 that prominently displays the total strength of a drug in a container, which can be emphasized using one or a combination of labeling characteristics. As shown in FIG. 4 and FIG. 5, the concentration, which is the number “5,000” in these figures, is assigned the largest font on the label. The concentration identified in these figures is contained in a second section of the label that has a different background color (i.e., black) than the background color in the first section (i.e., orange) around the second section that contains all remaining information about the drug product including the product name, conditions of use, NDC number, storage conditions, manufacturer, etc. Moreover, the color of the text in the second section of the label (i.e., white) is distinguishable from the color of the text in the first section (i.e., black). As shown in FIG. 3 and FIG. 10, the concentration can be presented in a generally consistent manner across vials containing different total strengths such that the concentration is quickly recognizable by those health care personnel who handle the drug product.

The background color of the second section containing the concentration, total strength and/or fill volume is chosen to contrast and stand out from the background color used for the first section of the label surrounding the second section. A similar effect can be employed for the text identifying the concentration, total strength and/or fill volume in the second section. For example, when the second section is black or a similar dark color, the text can be presented in a color, such as white, that stands out in contrast to the darker background. Similarly, when a lighter color is used for the second section, the text for the total strength can be emphasized with darker text. The same effect can be employed for the background color and text in the first section of the label.

For fill volume amounts of 1 mL in a vial, as shown in FIG. 4 and FIG. 5, the notation “USP units per mL” can be included in the second section of the label along with the total strength. To emphasize the number representing the total strength, the notation “USP units per mL” can be provided in a smaller font than the number for total strength. The use of the term “per” instead of the commonly used slash (i.e., “/”) eliminates the possibility that the slash could be misinterpreted for the number one.

In vials containing more than 1 mL of fluid, the fill volume in the vial can be provided on the same line and in the same font size as the total strength (shown as “50,000 USP units per 10 mL” in FIG. 8) in a second section, and a third section can be provided with the concentration (i.e., amount per mL). For example, as shown in FIG. 8, for a vial containing a total strength of 50,000 USP units in 10 mL of solution (identified as “50,000 USP units per 10 mL”), the concentration (identified as “5,000 USP units per mL”) is provided in a third section of the label that has a smaller font and background color that contrasts with the first and second sections.

By identifying the total strength on all containers, each total strength is represented by unique indicia shown in the second section of the label. As shown in FIG. 3, the nine unique indicia for Heparin Sodium, USP include the following: “1,000 USP units per mL,” “5,000 USP units per mL,” “10,000 USP units per mL,” “20,000 USP Units per mL,” “2,000 USP units per 2 mL,” “40,000 USP units per 4 mL,” “50,000 USP units per 10 mL,” “10,000 USP units per 10 mL,” and “30,000 USP units per 30 mL.” As with the font for the total strength, the font for concentration may also be larger than the adjacent phrase reading “USP units per mL”.

For flush codes of heparin, unique indicia can include multiple containers having different total strengths and fill volume each with the same concentration of 100 USP units per mL including the following: 1000 USP units per 10 mL; 3000 USP units per 30 mL; and 100 USP units per 1 mL Additional heparin flush codes having the same concentration of 10 USP units per mL include the following: 100 USP units per 10 mL; 500 USP units per 5 mL; and 10 USP units per 1 mL.

Because the total strength and concentration for heparin drug products all contain at least one zero and often several zeros, when these values are greater than three digits, a comma can be employed to break up the zeros. In addition, to further improve the readability of the total strength and concentration, the commas for each of these values can be lined up with one above the other such as shown in FIG. 8. Further, a place-holder may be left in the place of the ten-thousands digit for numbers that contain only four digits in an effort to focus attention to the number of zeros present. The recognition of the number of zeroes is critically important, as fatal mistakes have been made in the past that involved confusing 10 USP Units per mL with 10,000 USP Units per mL.

As shown in FIG. 5 and FIG. 8, the labeling system can display information such as the drug name, strength, and concentration in a horizontal orientation or a vertical orientation. In particular, for taller vials, it may be desirable to utilize the larger height of the vial by shifting sections of the label to a vertical orientation in order to increase the font sizes and create variation between containers having other total strengths. For example, the drug name, strength, and concentration are shown in a vertical orientation in FIG. 8, while these properties are displayed in a horizontal orientation in FIG. 5.

The orientation and font size may be chosen such that at least the drug name and total strength (and concentration if different from the total strength) are all viewable in their entirety without rotating the vial. This is important because requiring the clinician to rotate the vial to read it can result in misreading the label. Variations in font size and boldness can also be used to differentiate information on the label. The use of both vertical and horizontal orientations within the heparin family further distinguishes the vials that contain more than one mL of solution from those that contain only one mL.

In addition to the information already discussed above, the labeling system may further include the following: route of administration; “Rx Only” statement; vial contents; vial size; dosage information; National Drug Code (NDC) number; labeling raw material number; single or multi-dose vial identifier; bar code (including number); lot number; storage information; expiration date; manufacturer/distributor; country of origin; and warning statements. It will be appreciated that the labeling system can incorporate any other suitable information as required by FDA or dictated by USP standards.

As mentioned, drugs are commonly provided in different fill volumes and concentrations for different patient applications. For example, FIG. 3 shows nine different vials of Heparin Sodium Injection, USP wherein each vial has a different total strength. The labeling system can accentuate the different total strengths using a color scheme that provides a unique color for each total strength. Each container for a particular total strength is identifiable by both its total strength prominently displayed on the label (as described above) in addition to the uniquely assigned color scheme present on the label. Thus, a color scheme of this type provides a secondary mechanism to assist a clinician with the identification and administration of the correct drug dosage. The color assigned to a particular total strength can be used on the majority of the label for the container such that it stands out regardless of orientation of the container.

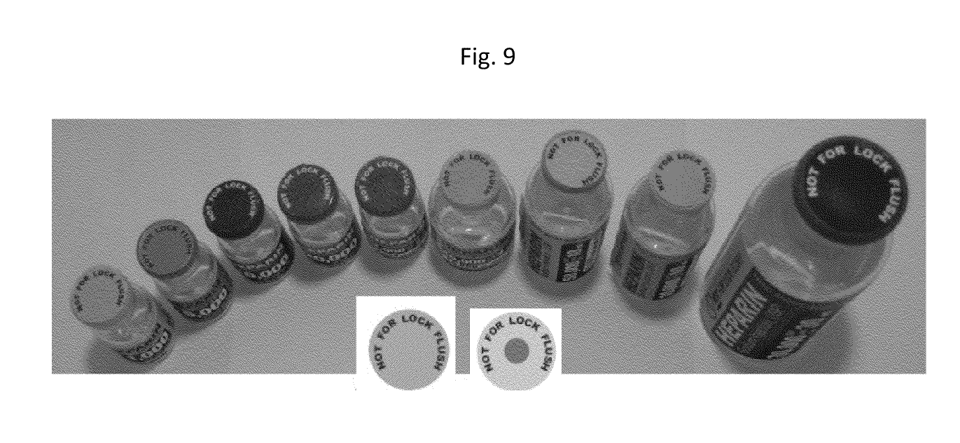

As shown in FIGS. 3, 4, 6, and 9, the color scheme can be extended to the cap such that the total strength in the vial is recognizable when looking downward onto the vial. This is helpful, for example, when identifying a vial that is stored in a bin, tray or drawer. If the wrong vial has been placed into a storage unit assigned to a different total strength, the user would readily see the mistake. The color scheme can be chosen to make the colors used for different total drug strengths and concentrations distinctive from one another, such as by avoiding repetition of pantone shades. In addition, the color scheme can take into account any historic usage of a particular color to avoid confusion. For example, shades of blue have historically been used for vials of the heparin lock flush product, so the color scheme employed with the vials of the heparin sodium product (labeled “Not For Lock Flush” in the figures) can avoid the usage of similar blue colors for these vials. Color selection has been tested for color-blindness by ensuring that all colors are sufficiently contrasted from each other.

As shown, the label and labeling system can accommodate one or more caution or warning statements. For example, the vials of heparin shown in the figures are Heparin Sodium Injection, USP and are not to be used for a lock flush. To alert the clinician to this warning, a conspicuous part of the label having a distinctive color, known as the warning section, can be used to alert the clinician that the drug is “NOT FOR LOCK FLUSH.” Symbols may also be used such as the universal “not” symbol shown as a circle with the diagonal line represented in FIG. 4, FIG. 5 and FIG. 8.

As an example, the warning section can be a color that contrasts with other colors on the label. Suitable colors for the warning section include yellow for labels that do not use yellow on other sections, and red for labels that do not use red on other sections. On certain vials, the warning section can be oriented 90° from the adjacent text identifying the drug name and total strength. The warning section may be die cut from the label to provide a different shape that draws attention to the warning.

It will be appreciated that any suitable text and/or symbols may be provided in the warning section as is appropriate for a particular drug. In addition, it will be appreciated that the warning section can use any suitable color and the text used for the warning can be chosen to stand out to a clinician.

Information can also be supplied on the caps or ferrules of drug vials. For example, additional warnings, such as “NOT FOR LOCK FLUSH,” may be provided on a cap such as shown in FIG. 6 and/or a ferrule for a vial such as shown in FIG. 7. Providing such a warning on the cap and/or ferrule functions as an active reminder just prior to administration of the drug. In addition to warnings, other suitable information could be displayed on the caps and/or ferrules, such as the total strength.

It will be appreciated that the labeling system can be utilized with any suitable container and packaging including, but not limited to, vials, bottles, boxes, cartons, trays, wrap (including premix bag overwraps and plastic wrap around trays), syringes, IV bags and blow-fill-seal packages. Further, it will be appreciated that multiple containers utilizing the labeling system can be used for a drug. For example, vials containing the drug product having the labeling system may be enclosed within a carton or a shrink-wrapped tray that also incorporates the labeling system. Multiple cartons having the labeling system can be placed into cases to which the labeling system is further applied.

The label of the invention may be applied to containers or packaging by any suitable means. For example, the label may be printed on paper, plastic or other suitable surface and then affixed to the container using an appropriate adhesive. This can be used for vials, bottles, trays and wraps. Alternatively, the label may be printed directly on the container. For example, the label is printed directly on the box or carton into one or more vials are placed for shipping.

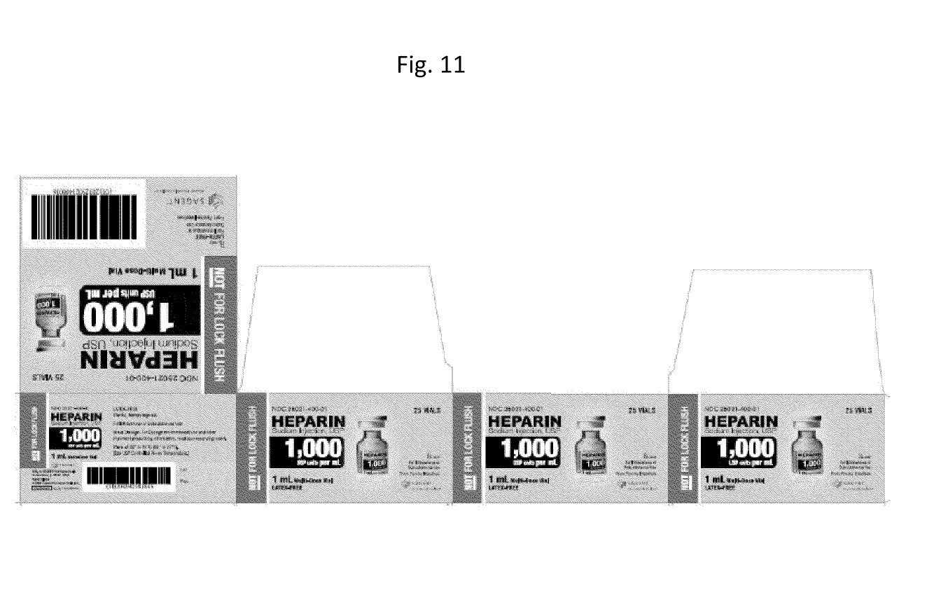

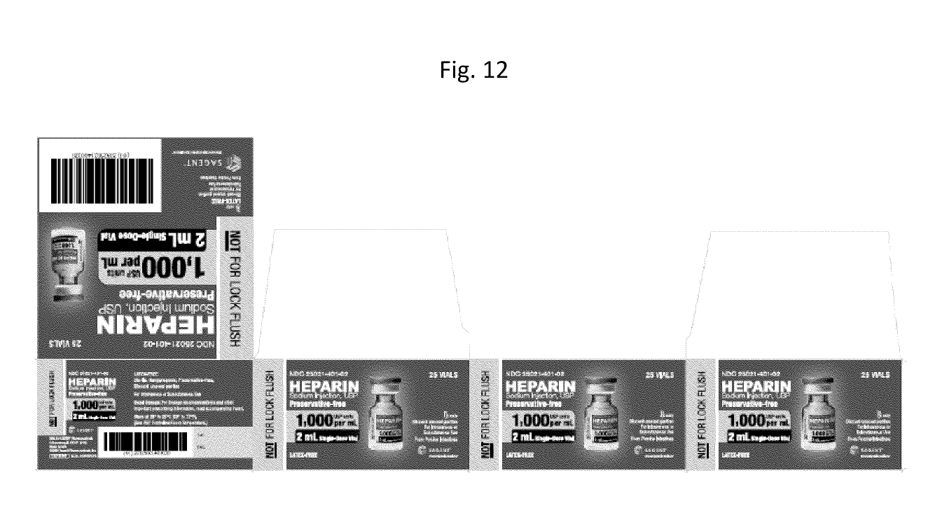

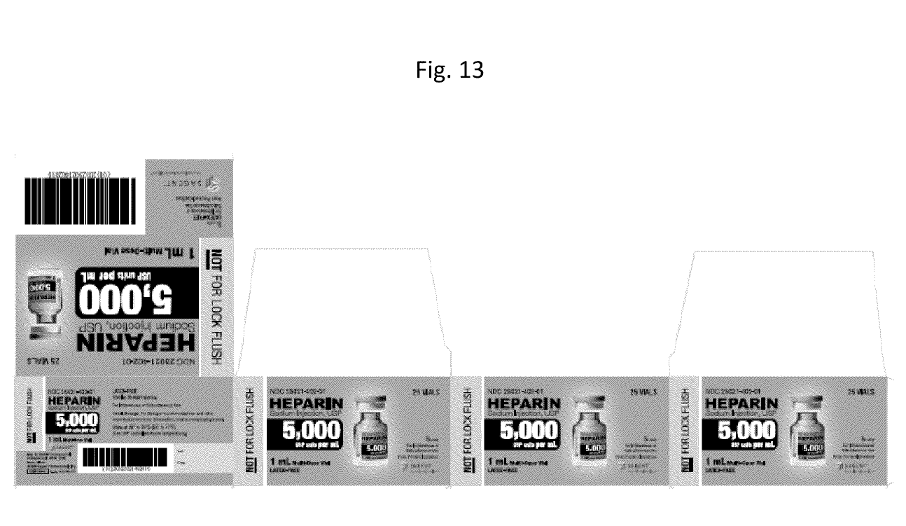

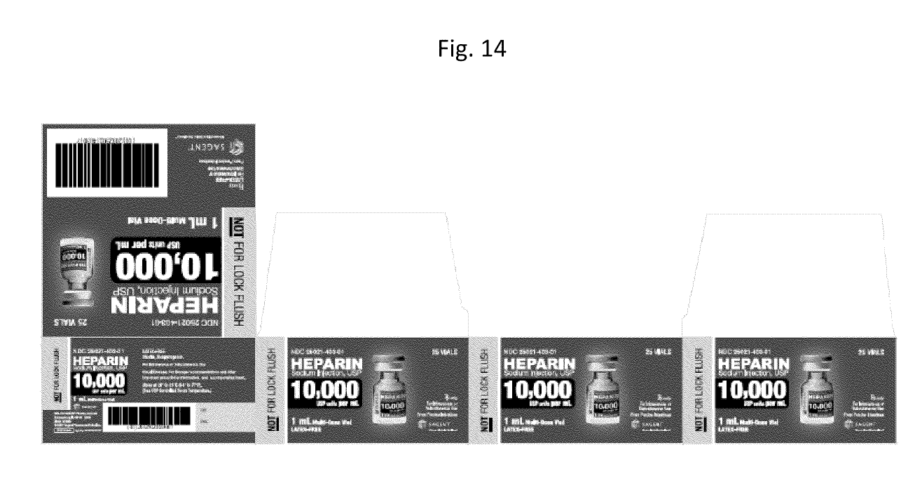

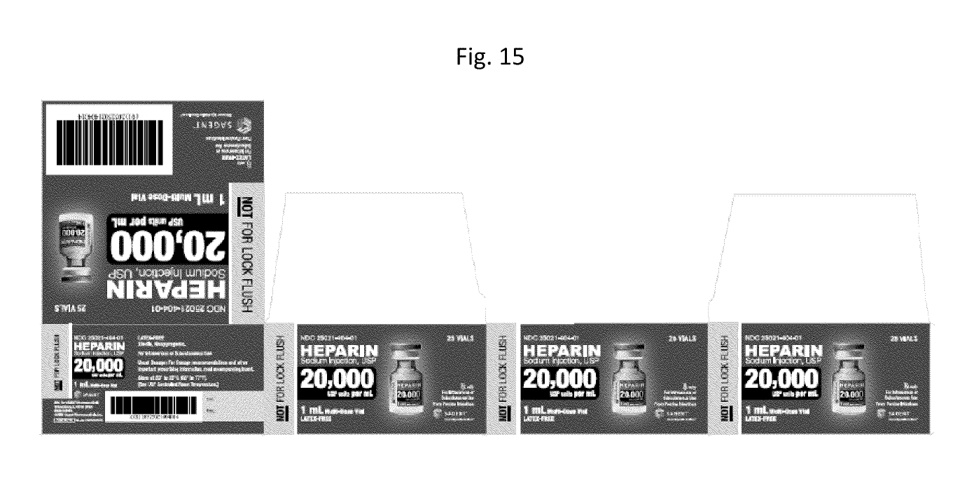

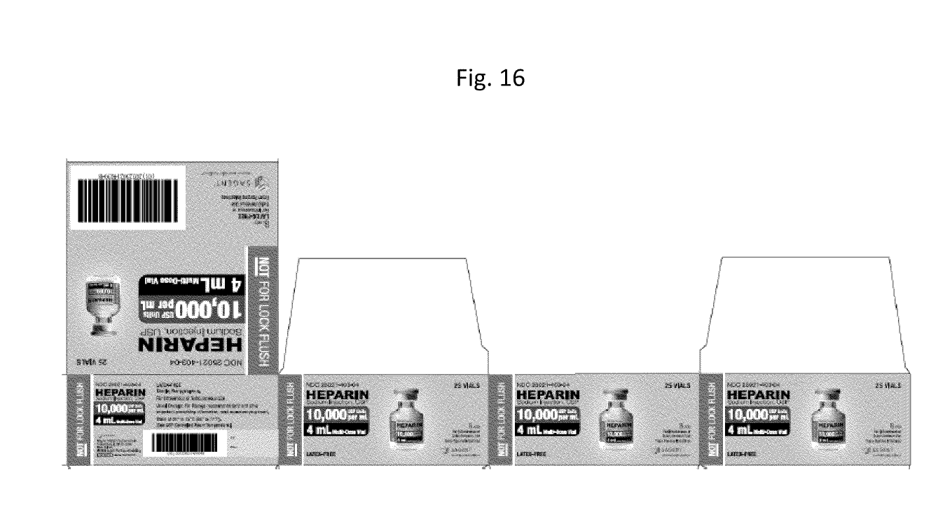

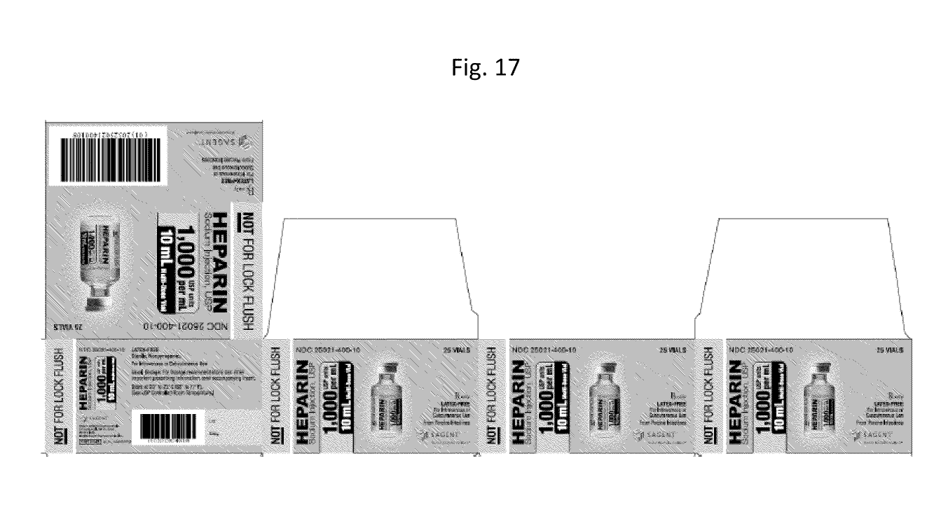

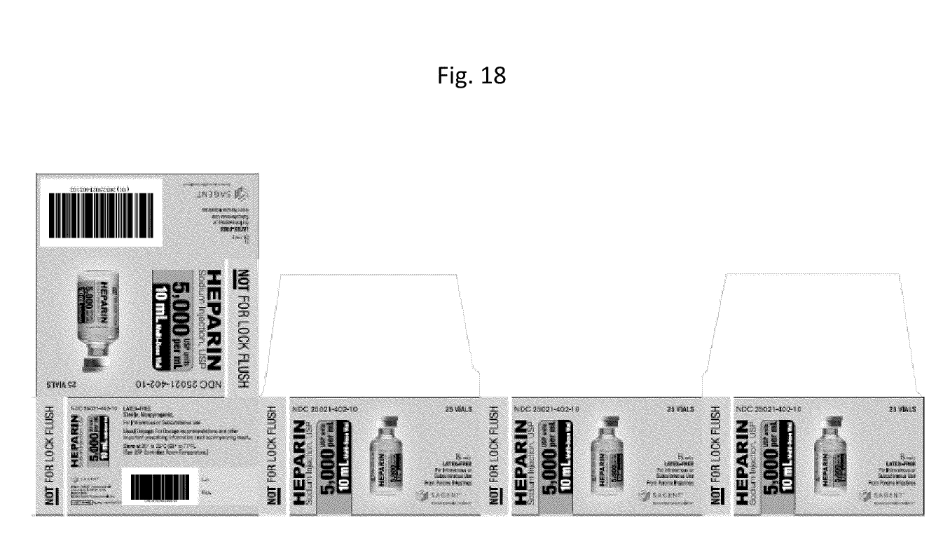

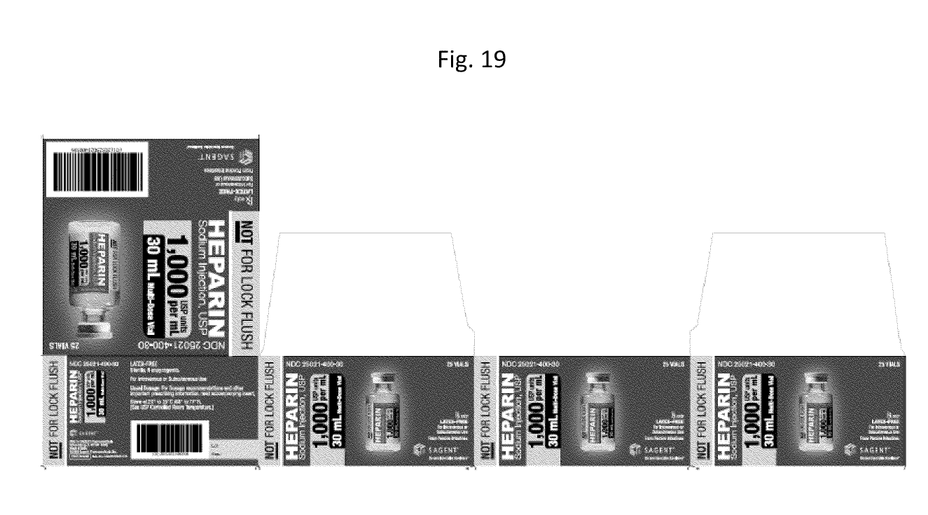

Sample cartons containing vials having different total strengths are shown in FIGS. 11-19. As shown, the sample cartons can utilize the labeling system on each side of the carton, including depictions or representations of the vials contained therein and prominent usage of the color associated with the respective total strength of the vials.

The labeling system of the invention for vials of Heparin Sodium Injection, USP using concentration format labels is shown in FIG. 20. The background color of the first section of the label for the vial containing 5,000 USP units per mL in a 1 mL fill volume is orange. Orange is the background color of the second section of the vials containing 5,000 USP units per mL in a 10 mL fill volume. Similarly, the yellow background color of the first section of the vial containing 1,000 USP units per mL in a 1 mL fill volume is the same color as the yellow background of the second section of the vials containing 1,000 USP units per mL in a 10 mL fill volume and 1,000 USP units per mL in a 30 mL fill volume. In addition, the brown background color of the first section of the vial containing 10,000 USP units per mL in a 1 mL fill volume is the same color as the brown background of the second section of the vial containing 10,000 USP units per mL in a 4 mL fill volume.

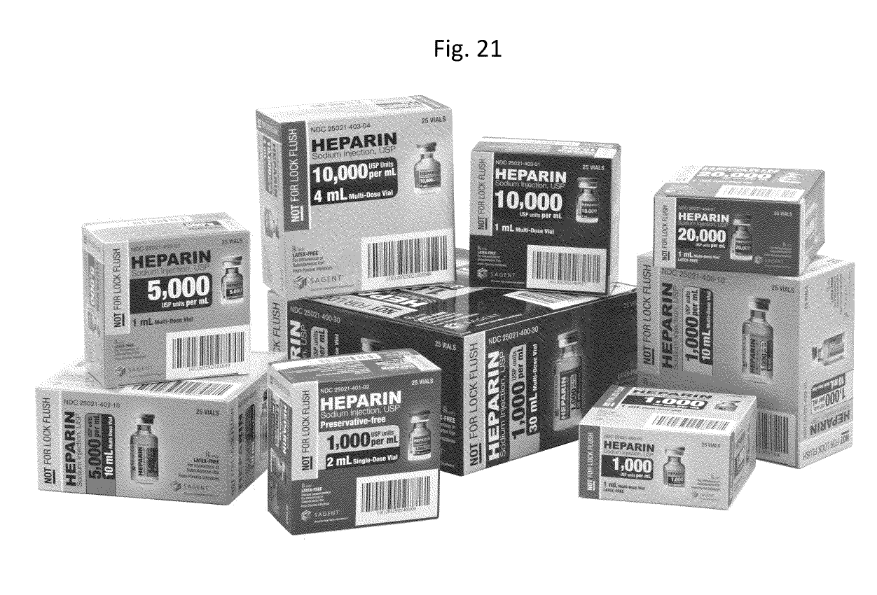

The labeling system of the invention present on cartons for Heparin Sodium Injection, USP using concentration format labels is shown in FIG. 21. The labels on the cartons are the same as the labels present on the vials as shown in FIG. 20.

It will be appreciated that the labeling system may be utilized on the container in a suitable manner such that the most important properties of the drug are recognizable from its typical storage position, such as lying on its side in the drawer of a crash cart. It will also be appreciated that using the labeling system on all sides of a carton or similar container ensures that the essential information for identification is viewable regardless of storage orientation.

The background color used for the first section of the label is different from the color of the second section containing the concentration of the drug product. When both a second section containing the total strength and fill volume and a third section containing the concentration are present on the label, a different background color is used in each of the first, second and third sections. The different colors for each of these sections of the label can be chosen such that they contrast and stand out from each other. As an example, if the first section of the label is green, the second section containing the total strength can be black, and the third section containing the concentration can be light gray. Additional warning information can be provided in a section of the label having a yellow background for further emphasis.

As illustrated in FIG. 10, the background color of the first and second sections of the labels in the labeling system of the invention are selected such that the color in the second section correlates back to the color in the first section having the same concentration while also having a unique background color to signify the presence of a different total strength. For example, the second section of the label for the vial having a total strength of 50,000 USP units (5,000 USP units per mL with a 10 mL fill volume) is the color which is the same color—orange—as the background of the first section of the label for the vial that has the same concentration of 5,000 USP units per mL in a 1 mL fill volume. Likewise the second section for the labels for the vials having total strengths of 30,000 USP units (1,000 USP units per mL with a 30 mL fill volume) and 10,000 USP units (1,000 USP units per mL with a 10 mL fill volume) are the same color—yellow—as the background of the first section of the label for the vial that has the same concentration of 1,000 USP units per mL in a 1 mL fill volume.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A label for a container for a drug product comprising:
a first section having a background color and text identifying the drug product name; and
a second section having a background color identifying the concentration of the drug product and text identifying the concentration of the drug product, and
wherein the background color of the first section is different from the background color of the second section.

2. The label of claim 1, wherein the first section further identifies the fill volume of the container.

3. The label of claim 1, further comprising a third section identifying the fill volume of the container,
wherein the background color of third section is different from the background color of the first and second sections.

4. The label of claim 1, wherein the drug product is heparin.

5. The label of claim 1, wherein the label further includes an information section comprising at least one of a die cut portion and a portion highlighted by contrasting colors.

6. The label of claim 1, wherein the container is selected from the group consisting of a vial, bottle, box, carton, tray, wrap, syringe, IV bag, cartridge, and blow-fill-seal package.

7. A label for a container for a drug product comprising:
a first section having a background color and text identifying the drug product name;
a second section having a background color identifying the total strength and fill volume and text identifying the total strength and fill volume, and
wherein the background color of the first section is different from the background color of the second section.

8. The label of claim 7, further comprising a third section having a background color and text identifying the concentration of the drug product,
wherein the background color of third section is different from the background color of the first and second sections.

9. The label of claim 7, wherein the drug product is heparin.

10. The label of claim 7, wherein the label further includes an information section comprising at least one of a die cut portion and a portion highlighted by contrasting colors.

11. The label of claim 7, wherein the container is selected from the group consisting of a vial, bottle, box, carton, tray, wrap, syringe, cartridge, and IV bag.

12. A labeling system for multiple containers for a drug product comprising labels applied to two or more containers, wherein each label comprises:
a first section having a background color and text identifying the drug product name and the fill volume in the container; and
a second section having a background color identifying the concentration of the drug product and text identifying the concentration of the drug product,
wherein the background color of the first section is different from the background color of the second section, and
wherein the background color of the first section of the label is different for each container for drug product having a different total strength.

13. The labeling system of claim 12, wherein at least two labels are applied to containers for drug product having the same concentration and different total strength and different fill volume, and
wherein one of the labels is applied to a container having a fill volume of 1 mL and other label is applied to a container having a fill volume of more than 1 mL, and
wherein the background color of first section of the label for the container having a 1 mL fill volume is the same as the background color of the second section of the label for the container having a fill volume of more than 1 mL.

14. A labeling system for multiple containers for a drug product comprising labels present on two or more containers, wherein each label comprises:
a first section having a background color and text identifying the drug product name; and
a second section having a background color identifying the total strength of the drug product and fill volume and text identifying the total strength of the drug product and fill volume,
wherein the background color of the first section is different from the background color of the second section, and
wherein the background color of the first section of the label is different for each container for drug product having a different total strength.

15. The labeling system of claim 14, wherein at least two labels are applied to containers for drug product having the same concentration and different total strength and different fill volume, and
wherein one of the labels is applied to a container having a fill volume of 1 mL and other label is applied to a container having a fill volume of more than 1 mL, and
wherein the background color of first section of the label for the container having a 1 mL fill volume is the same as the background color of the second section of the label for the container having a fill volume of more than 1 mL.

16. A method of labeling containers for a drug product comprising:
utilizing indicia on a label for the drug product, the indicia identifying properties of the drug product, the properties including a name of the drug product, concentration, total strength and fill volume;
utilizing a background color for a first section of the label containing the name of the drug product, such color being uniquely associated with the total strength of the drug product; and
utilizing a background color for a second section of the label containing the concentration of the drug product, wherein the background color of the second section is different that the background color of the first section.
